(19) United States
(12) Patent Application Publication
(10) Pub. No.: US 2023/0182714 A1
(43) Pub. Date: Jun. 15, 2023

(54) HYBRID DRIVE SYSTEM FOR ELECTRIC VEHICLE AND METHOD TO OPERATE THE SAME

(71) Applicant: Anoop Ravi Macgan, Bangalore (IN)

(72) Inventor: Anoop Ravi Macgan, Bangalore (IN)

(21) Appl. No.: 17/906,366

(22) PCT Filed: Mar. 30, 2021
(86) PCT No.: PCT/IB2021/052626

§ 371 Date: Sep. 15, 2022

(30) Foreign Application Priority Data
Mar. 30, 2020 (IN) 202041013859

(51) Int. Cl. B60W 20/13; B60K 6/26; B60K 6/543

(52) U.S. Cl. CPC B60W 20/13; B60K 6/26; B60K 6/543; B60K 2006/268; B60Y 2200/92; B60Y 2200/12; B60W 2300/36; B60W 2510/081

(57) ABSTRACT

A hybrid drive system for electric vehicle is disclosed. The system includes a rear wheel. The system also includes a first motor mechanically coupled to the rear wheel and an internal combustion engine. The first motor is configured to drive power for the electrical vehicle to reach a fraction of a predetermined threshold value of rotations per minute (RPM). The system also includes a second motor mechanically coupled to the internal combustion engine via the chain drive transmission unit with a one way bearing. The second motor is configured to receive an activation signal to power the internal combustion engine to transfer the power driven to the rear wheel via the continuously variable transmission unit upon attaining the fraction of the predetermined threshold value of rotations per minute (RPM) by the first motor.

### CROSS-REFERENCE TO RELATED APPLICATION

This National Phase Application claims priority from a complete patent application filed in India having Patent Application No. 202041013859, filed on Mar. 30, 2020 and titled “HYBRID DRIVE SYSTEM FOR ELECTRIC VEHICLE AND METHOD TO OPERATE THE SAME” and a PCT Application No. PCT/IB2021/052626 filed on Mar. 30, 2021, and titled “HYBRID DRIVE SYSTEM FOR ELECTRIC VEHICLE AND METHOD TO OPERATE THE SAME”.

### FIELD OF INVENTION

Embodiments of a present disclosure relate to an electric vehicle, and more particularly to a hybrid drive system for electric vehicle and a method to operate the same.

### BACKGROUND

Electric vehicle uses one or more electric motors or traction motors for propulsion. Also, the electric vehicle provides an effortless form of transport regardless of the physical abilities of the riders. In addition, the electric vehicle produces lower emission as compared to vehicles driven by conventional energy source. On the other hand, the electric vehicle takes long hours for charging a battery and often require heavy and expensive battery packs. Various drive systems of electric vehicle are available which uses a conventional engine and a transmission arrangement to extend the electric vehicle's range and practicality.

However, in such systems, the internal combustion engine engages continuously to power the electric vehicle which in turn consumes a lot of fuel. Also, the electric motors have a fixed transmission ratio which is incapable of overcoming varying gradients over which the vehicle might be traversing and at the same time provide high speeds. Also, by drawing heavy currents from one or more batteries, the entire system might be made to work under reduced efficiency yielding much lesser battery life.

Hence, there is a need for an improved hybrid drive system for electric vehicle and a method to operate the same in order to address the aforementioned issues.

### BRIEF DESCRIPTION

In accordance with an embodiment of the disclosure, a hybrid drive system for electric vehicle is disclosed. The system includes a rear wheel. The system also includes a first motor mechanically coupled to the rear wheel and an internal combustion engine. The first motor is configured to drive power for the electrical vehicle to reach a fraction of a predetermined threshold value of rotations per minute (RPM). The system also includes a second motor mechanically coupled to the internal combustion engine via the chain drive transmission unit with a one way bearing. The second motor is configured to receive an activation signal from the motor controller and send power to the internal combustion engine to transfer the power driven to the rear wheel via the continuously variable transmission unit upon attaining the fraction of the predetermined threshold value of rotations per minute (RPM) by the first motor.

In accordance with another embodiment of the disclosure, a method of operating a hybrid drive system of an electric vehicle is disclosed. The method includes driving power for the electrical vehicle to reach a fraction of a predetermined threshold value of rotations per minute (RPM). The method also includes receiving an activation signal from the motor controller and send power to an internal combustion engine to transfer the power driven to the rear wheel via the continuously variable transmission unit upon attaining the fraction of the predetermined threshold value of rotations per minute (RPM) by the first motor.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram representation of a hybrid drive system for an electric vehicle in accordance with an embodiment of the present disclosure;

FIG. 2 is a schematic representation of the hybrid drive system for the electric vehicle of FIG. 1 in accordance with an embodiment of the present disclosure;

FIG. 3 is an embodiment representing a top view of the hybrid drive system for the electric vehicle of FIG. 2 in accordance with an embodiment of the present disclosure;

FIG. 4 is another embodiment representing a side view of the hybrid drive system for the electric vehicle of FIG. 3 in accordance with an embodiment of the present disclosure; and

FIG. 5 is a flow diagram representing steps involved in a method of operating a hybrid drive system of an electric vehicle in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . , a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a hybrid drive system for an electric vehicle and a method to operate the same. The system includes a rear wheel. The system also includes a first motor mechanically coupled to the rear wheel and an internal combustion engine. The first motor is configured to drive power for the electrical vehicle to reach a fraction of a predetermined threshold value of rotations per minute (RPM). The system also includes a second motor mechanically coupled to the internal combustion engine via a chain drive transmission unit with a one way bearing. The second motor is configured to receive an activation signal from the motor controller and send power to the internal combustion engine to transfer the power driven to the rear wheel via the continuously variable transmission unit upon attaining the fraction of the predetermined threshold value of rotations per minute (RPM) by the first motor.

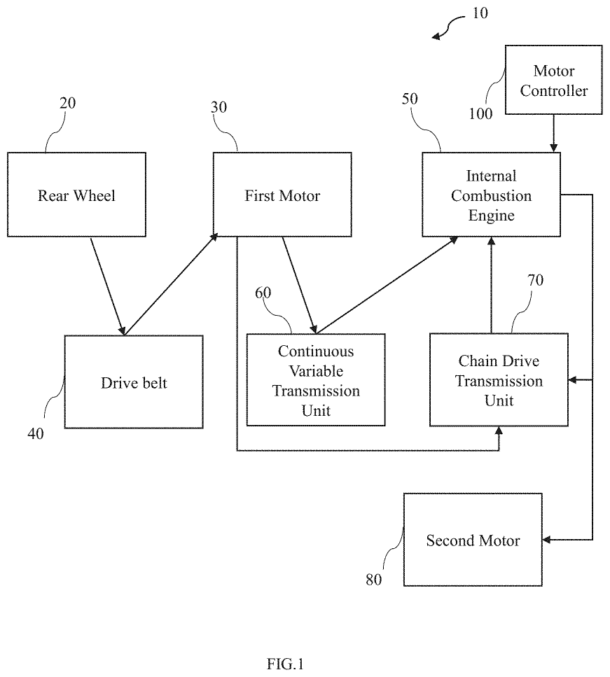

FIG. 1 is a block diagram representation of a hybrid drive system 10 for an electric vehicle in accordance with an embodiment of the present disclosure. The system 10 includes a first motor 30 operatively coupled to an internal combustion engine 50 via at least one of a continuously variable transmission (CVT) unit 60, a chain drive transmission unit 70 or a combination thereof. The system 10 also includes a rear wheel 20 operatively coupled to the first motor 30 via a drive belt 40. Further, the system 10 also includes a second motor 80 operatively coupled to the internal combustion engine 50 via the chain drive transmission unit 70. The system 10 also includes a motor controller 100 configured to send an activation signal to the internal combustion engine 50 to transfer power to the rear wheel 20.

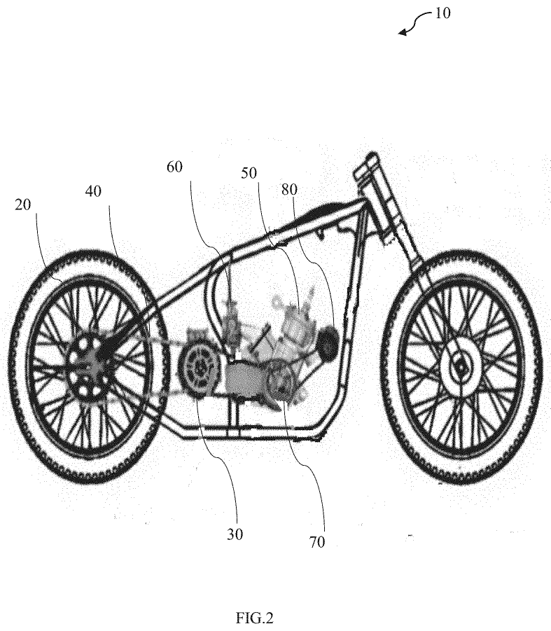

FIG. 2 is a schematic representation of the hybrid drive system 10 for the electric vehicle of FIG. 1 in accordance with an embodiment of the present disclosure. In one specific embodiment, the electric vehicle includes a hybrid drive system 10. The hybrid drive system includes a rear wheel 20, a first motor 30, an internal combustion engine 50, a drive belt 40, a second motor 80, a chain drive transmission unit 70 and a continuously variable transmission unit 60. The first motor 30 is mechanically coupled to the rear wheel 20 via the continuously variable transmission (CVT) unit 60 by means of the drive belt 40.

In one embodiment, the continuously variable transmission unit 60 may be embedded into the rear wheel 20 of the electric vehicle. In another embodiment, the continuously variable transmission unit 60 may be mounted separately and connected to the rear wheel 20. As used herein, the term “OFF” unit is an automatic transmission that uses two pulleys with a steel belt running between them. Also, to continuously vary its gear ratios, the CVT simultaneously adjusts the diameter of the “drive pulley” that transmits torque from the engine and the “driven pulley” that transfers torque to the wheels.

Further, the first motor 30 is also mechanically coupled to the internal combustion engine 50 via at least one of the continuously variable transmission unit (60), the chain drive transmission unit 70 or a combination thereof. In one embodiment, the chain drive transmission unit 70 may include a chain and sprocket drive. As used herein, the term “chain and sprocket drive” is a type of power transmission in which a roller chain engages with two or more toothed wheels or sprockets, used in engines as a drive from crankshaft to camshaft.

Further, the first motor 30 drives power for the electric vehicle to reach a fraction of a predetermined threshold value of rotations per minute (RPM) via the continuously variable transmission unit 60. In one exemplary embodiment, the continuously variable transmission unit 60 activates progressively in order to reach the fraction of the predetermined threshold value of rotations per minute (RPM). In such embodiment, the fraction of the predetermined threshold value of rotations per minute (RPM) may include half of the predetermined threshold value of rotations per minute (RPM).

Furthermore, the second motor 80 is mechanically coupled to the internal combustion engine 50 via the chain drive transmission unit 70 with a one way bearing. In one embodiment, an anti-reverse bearing may be used to transfer the power between the second motor 80 and the internal combustion engine 50.

The second motor 80 receives an activation signal from the motor controller and send power to the internal combustion engine 50 to transfer the power driven to the rear wheel 20 via the continuously variable transmission (CVT) unit 60 upon attaining the fraction of the predetermined threshold value of rotations per minute (RPM) by the first motor 30. Further, in one embodiment, the second motor 80 also generates electricity for charging a battery within the electric vehicle when the first motor 30 drives power for the electric vehicle to reach the fraction of the predetermined threshold value of rotations per minute (RPM). In such embodiment, the fraction of the predetermined threshold value of rotations per minute may include half of the predetermined threshold value of rotations per minute.

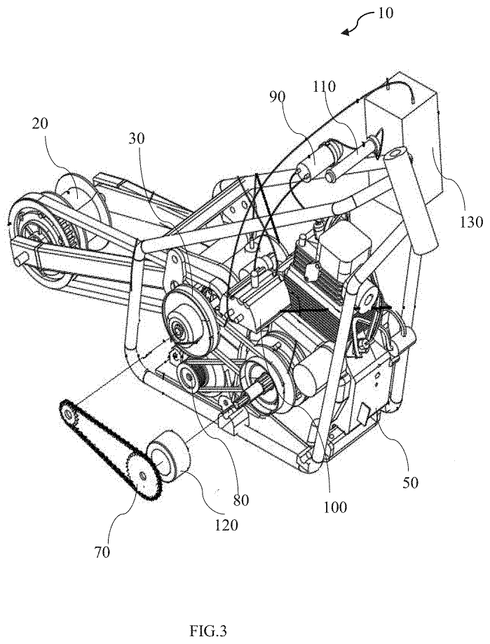

FIG. 3 is an embodiment representing a top view of the hybrid drive system 10 for the electric vehicle of FIG. 2 in accordance with an embodiment of the present disclosure. The system includes a first motor 30 mechanically coupled to an internal combustion engine 50 via at least one of the continuously variable transmission unit 60, the chain drive transmission unit 70 or a combination thereof. In one embodiment, the chain drive transmission unit 70 may include a chain and sprocket drive 70.

Further, the first motor 30 drives power for the electric vehicle to reach a fraction of a predetermined threshold value of rotations per minute (RPM) via the continuously variable transmission unit 60. In such embodiment, the fraction of the predetermined threshold value of rotations per minute (RPM) may include half of the predetermined threshold value of rotations per minute (RPM). In some embodiment, the first motor 30 generates electricity for charging a battery 130 within the electric vehicle during deceleration of the electric vehicle.

Furthermore, the second motor 80 is mechanically coupled to the internal combustion engine 50 via the chain drive transmission unit 70 with a one way bearing. In one embodiment, an anti-reverse bearing may be used to transfer the power between the second motor 80 and the internal combustion engine 50. Further, the system 10 also includes a throttle controller 90 configured to sense a value of rotations per minute (RPM) of the first motor 30 using one or more sensors (as not shown in FIG. 3) wherein the one or more sensors are built within the throttle controller 90. In one embodiment, the one or more sensors may include a throttle position sensor. Further, the throttle controller 90 sends an alert signal to a motor controller 100 to decide a position of a throttle 110 upon attaining the fraction of the predetermined threshold value of rotations per minute by the first motor 30. As used herein, the term “throttle” controls the power to the internal combustion engine.

Further, the second motor (80) sends an activation signal to the internal combustion engine 50 to transfer the power driven to the rear wheel 20 via the continuously variable transmission (CVT) unit 60 upon attaining the fraction of the predetermined threshold value of rotations per minute by the first motor 30. In one embodiment, the chain drive transmission unit 70 may be activated via a centrifugal clutch system 120. In such embodiment, a gear ratio of the chain drive transmission unit 70 is about 0.6 to about 0.8:1. As used herein, the term “centrifugal clutch” refers to a clutch that uses centrifugal force to connect two concentric shafts, with the driving shaft nested inside the driven shaft.

In another embodiment, the system 10 may include an electronic control unit configured to generate command to exchange a drive unit based on a user preference. In such embodiment, the drive unit may be represented as the internal combustion engine 50 or the first motor 30. Further, in one specific embodiment, the second motor 80 also generates electricity for charging a battery 130 within the electric vehicle during the first motor 30 drives power for the electric vehicle to reach the fraction of a predetermined threshold value of rotations per minute (RPM). In one embodiment, the system 10 may also include a battery management unit activates the internal combustion engine 50 for re-charging the battery 130 using a motor controller 100 when a battery level reaches below a predefined threshold value.

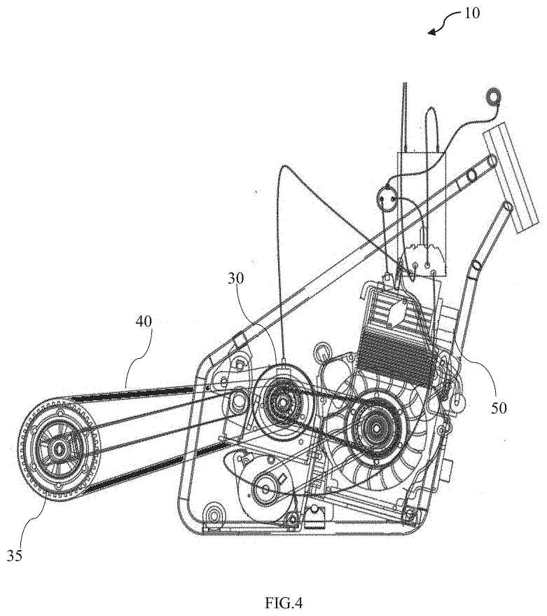

FIG. 4 is another embodiment representing a side view of the hybrid drive system 10 for the electric vehicle of FIG. 2 in accordance with an embodiment of the present disclosure. In one embodiment, the system 10 may include a secondary drive shaft 35 coupled to the rear wheel. In such embodiment, a power driven by the first motor 30 flows from the internal combustion engine 50, through the secondary drive shaft 35 to the rear wheel.

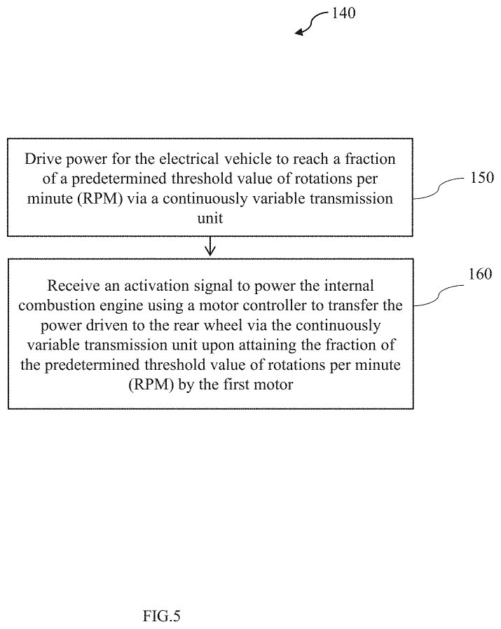

FIG. 5 is a flow diagram representing steps involved in a method 140 of operating a hybrid drive system of an electric vehicle. The method 140 includes driving, by a first motor, power for the electric vehicle to reach a fraction of a predetermined threshold value of rotations per minute (RPM) via the continuously variable transmission unit in step 150. In one embodiment, reaching the fraction of the predetermined threshold value of rotations per minute (RPM) may include reaching half of the predetermined threshold value of rotations per minute (RPM). In one specific embodiment, the method 140 may include generating, by the first motor, electricity for charging a battery within the electric vehicle during deceleration of the electric vehicle.

The method 140 also includes receiving, by a second motor, an activation signal from the motor controller and send power to the internal combustion engine to transfer the power driven to the rear wheel via the continuously variable transmission (CVT) unit upon attaining the fraction of the predetermined threshold value of rotations per minute (RPM) by the first motor in step 160. In one embodiment, the method (140) may include generating, by the second motor, the electricity for charging the battery during the first motor drives the power for the electric vehicle to reach the fraction of the predetermined threshold value of rotations per minute (RPM). In one specific embodiment, the method 140 may include activating, by a battery management unit, the internal combustion engine for re-charging the battery using the motor controller when a battery level reaches below a predefined threshold value.

Various embodiments of the present disclosure provide a technical solution to the problem of drive system of an electric vehicle. The present disclosure provides an efficient drive system for the electric vehicle which saves a lot of fuel by introducing a second motor which activates an internal combustion engine only when a value of rotations per minute of the first motor exceeds a predefined threshold value of the rotations per minute. Also, the present system increases the battery life of the electric vehicle by activating the internal combustion engine for re-charging the battery using the motor controller when a battery level reaches below a predefined threshold value.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A hybrid drive system for an electric vehicle comprising:
a rear wheel;
a first motor mechanically coupled to the rear wheel and an internal combustion engine, wherein the first motor is configured to drive power for the electrical vehicle to reach a fraction of a predetermined threshold value of rotations per minute (RPM); and
a second motor mechanically coupled to the internal combustion engine via the chain drive transmission unit with a one way bearing, wherein the second motor is configured to receive an activation signal from motor controller and to start the internal combustion engine and to transfer the power driven to the rear wheel via the continuously variable transmission unit upon attaining the fraction of the predetermined threshold value of rotations per minute (RPM) by the first motor.

2. The system as claimed in claim 1, wherein the first motor is mechanically coupled to the internal combustion engine via at least one of the continuously variable transmission unit, the chain drive transmission unit or a combination thereof.

3. The system as claimed in claim 1, wherein the fraction of the predetermined threshold value of rotations per minute (RPM) comprises half of the predetermined threshold value of rotations per minute (RPM).

4. The system as claimed in claim 1, wherein the first motor generates electricity for charging a battery within the electric vehicle during deceleration of the electric vehicle.

5. The system as claimed in claim 1, wherein the second motor generates the electricity for charging the battery when the first motor drives the power for the electric vehicle to reach the fraction of the predetermined threshold value of rotations per minute (RPM).

6. The system as claimed in claim 1, comprising a battery management unit configured to activate the internal combustion engine for re-charging the battery using the motor controller when a battery level reaches below a predefined threshold value.

7. A method of operating a hybrid drive system of an electric vehicle, the method comprising:
driving, by a first motor, power for the electrical vehicle to reach a fraction of a predetermined threshold value of rotations per minute (RPM); and
receiving, by a second motor, an activation signal from the motor controller and send power to the internal combustion engine to transfer the power driven to the rear wheel via the continuously variable transmission unit upon attaining the fraction of the predetermined threshold value of rotations per minute (RPM) by the first motor

8. The method as claimed in claim 7, comprising generating, by the first motor, electricity for charging a battery within the electric vehicle during deceleration of the electric vehicle.

9. The method as claimed in claim 7, comprising generating, by the second. motor, the electricity for charging the battery during the first motor drives the power for the electric vehicle to reach the fraction of the predetermined threshold value of rotations per minute (RPM).

10. The method as claimed in claim 7, comprising activating, by a battery management unit, the internal combustion engine for re-charging the battery using the motor controller when a battery level reaches below a predefined threshold value.
